(19) United States
(12) Patent Application Publication
(10) Pub. No.: US 2018/0317453 A1
(43) Pub. Date: Nov. 8, 2018

(54) ANIMAL SHOE

(71) Applicant: Valerie WALKER, Glasgow (GB)

(72) Inventor: Valerie WALKER, Glasgow (GB)

(21) Appl. No.: 15/768,238

(22) PCT Filed: Oct. 20, 2016
(86) PCT No.: PCT/GB2016/053283

§ 371 Date: Apr. 13, 2018

(30) Foreign Application Priority Data
Oct. 22, 2015 (GB) 1518754.5

(51) Int. Cl. A01K 13/00; A01L 15/00; A01L 5/00; A01L 9/00

(52) U.S. Cl. CPC A01K 13/007; A01L 9/00; A01L 5/00; A01L 15/00

(57) ABSTRACT

A therapeutic shoe for cloven-hooved lactating animals protects a diseased or injured hoof from the external environment to promote healing. The shoe is notionally divided into four parts: a sole portion for supporting the undersides of the medial and lateral claws; a vamp portion connected to the sole portion for at least partially enveloping the hoof wall between its toe, heel and coronary band; a quarter portion connected to the vamp portion for at least partially enveloping the front and lateral pastern sections; and a heel portion connected to both the vamp and quarter portions for at least partially enveloping the heel and the area beneath the dew claws. The material of the shoe at the heel portion is relatively more deformable than the material of the shoe at the sole, vamp or quarter portions thus avoiding the application of excess pressure to this sensitive area of the hoof anatomy.

### CROSS-REFERENCE TO RELATED APPLICATIONS

This application is the U.S. national stage application of International Application PCT/GB2016/053283, filed Oct. 20, 2016, which international application was published on Apr. 27, 2017, as International Publication WO2017/068354 in the English language. The international application is incorporated herein by reference, in its entirety. The international application claims priority to GB Patent Application No. 1518754.5, filed Oct. 22, 2015, which is incorporated herein by reference, in its entirety.

### FIELD

The present invention relates to an animal shoe and particularly, though not exclusively, to a therapeutic shoe for cloven-hooved lactating animals.

### BACKGROUND

The incidence of foot disease in cloven-hooved farm animals—particularly dairy herds—is unfortunately very common. Examples of foot diseases include ulcers of the sole, heel or toe; digital dermatitis; interdigital growths; foul; and necrosis. Resulting lameness is a major worldwide problem facing the dairy farming industry which brings many costs for the dairy farmer including loss of milk production, higher veterinary bills, and additional labour costs for monitoring/medicating/culling the herd to contain disease. This represents a significant animal welfare issue which creates stress for both the animals and the farmer.

Efforts have of course been made to overcome or ameliorate the impact of foot disease for cloven-hooved farm animals. For example, hoof trimming and the application of foot blocks can be used as a preventative measure to ensure that the weight bearing surfaces of the foot are balanced. Hoof bathing systems are common whereby the herd is guided through a chemical bath containing antimicrobial ingredients for disinfecting and cleansing the hooves. However, such chemical baths may have only limited effect, particularly where an open lesion is present on an animal's hoof. It is impractical to maintain any degree of cleanliness immediately after exiting a chemical bath and any bacterial pathogens which are removed are unavoidably quickly replaced. Further disadvantages associated with chemical baths include their relatively high costs and concerns surrounding their toxicity both in respect of their potential harm to animals themselves, and to the environment. These and other measures are set out in a publication titled: “Hoof Care: field guide” published in 2014 by DairyCo, a division of the United Kingdom's Agriculture and Horticulture Development Board.

### SUMMARY

According to the present invention there is provided a therapeutic shoe for cloven-hooved lactating animals, said therapeutic shoe comprising:
a. a sole portion for supporting undersides of an animal's medial and lateral claws;
b. a vamp portion connected to the sole portion for at least partially enveloping an animal's hoof wall between its toe, heel and coronary band;
c. a quarter portion connected to the vamp portion for at least partially enveloping an animal's front and lateral pastern sections; and
d. a heel portion connected to both the vamp and quarter portions for at least partially enveloping an animal's heel and the area beneath the dew claws;

wherein the material of the shoe at said heel portion is relatively more deformable than the material of the shoe at any of said sole, vamp or quarter portions.

Advantageously, such an arrangement avoids the application of excess pressure to this sensitive area of the hoof anatomy.

Optionally, the increase in relative deformability of the heel portion is achieved by reducing the thickness and/or increasing the elasticity of the material of the shoe at said heel portion relative to that of the shoe at any of said sole, vamp or quarter portions.

By reducing the thickness and/or increasing the elasticity of the shoe material at this region the ligaments and blood supply leading to the remainder of the hoof is unimpeded which is an important factor in promoting the healing process.

Optionally, the relatively thinner material of the shoe at said heel portion has a variable thickness wherein a portion thereof most proximate the dew claws is relatively thinner and more flexible than the material of the remainder of the heel portion.

In one embodiment, the thickness of the heel portion will reduce progressively with increasing distance from the sole/heel junction towards the dew claws. This balances the need for sufficient support near the base of the heel with the increasing sensitivity of the hoof anatomy proximate the dew claws.

Additionally or alternatively, the increase in relative deformability of the heel portion is achieved by oversizing the heel portion.

The oversized material may be loose-fitting or baggy such that an appropriately tensioned fastener—such as an elastic band—is used to gather it against the animal's heel in a pleated or concertina fashion. Alternatively, the material may be oversized in the sense that it is provided with an inherent elasticity permitting it to be temporarily, e.g. manually, stretched during fitting or removal before resiliently shrinking against the surface of an animal hoof.

Optionally, the material of the shoe at said sole portion is relatively thicker and/or more rigid than the material of any other part of the shoe.

Optionally, the foremost part of the vamp portion is divided into separate medial and lateral sections for accommodating an animal's medial and lateral claws.

It will be appreciated that such a division within the vamp section creates two separate internal spaces within the shoe which maintains a physical separation between the medial and lateral claws. This arrangement may be beneficial to the treatment of certain types of hoof disease.

Optionally, an auxiliary connection is provided between the medial and lateral sections to resist and/or limit their physical separation.

Optionally, the auxiliary connection is in the form of a web connected between opposite inner surfaces of the medial and lateral sections.

Alternatively, the auxiliary connection is in the form of band connected between the medial and lateral sections.

In one embodiment, the web and/or band is provided with a degree of elasticity tending to return the medial and lateral sections to a relatively close proximity. In an alternative embodiment, the web and/or band is relatively rigid tending to maintain the medial and lateral sections in a constant proximity to one another.

Optionally, the outer surface of the sole is provided with a textured or patterned tread.

Optionally, the inner hoof-facing surface of the sole is provided with a textured or patterned tread.

Optionally, a sealable aperture is provided on the front of the shoe.

Optionally, the sealable aperture overlies the front of the vamp and/or quarter portion(s).

Advantageously, the sealable aperture is in the form of a plug which can be opened to permit ventilation of the enclosed hoof and/or to facilitate the introduction of a medicament.

Optionally, the entire shoe is integrally formed from a single piece of rubber or elastomeric material.

The absence of seams or joins ensures that the shoe remains fully waterproof which is advantageous in terms of promoting the healing process for an encapsulated injured or diseased hoof.

Optionally, the rubber or elastomeric material is breathable.

It may or may not be desirable for the material of the shoe to be breathable. It is therefore envisaged that all or part of the shoe—e.g. the vamp portion—may be provided with an outer non-breathable layer which is removable to reveal an underlying perforated or breathable layer.

Optionally, at least part of the material of the shoe is transparent

By providing a transparent shoe, or viewing windows at appropriate position(s), it becomes possible to monitor the healing process and/or view the accuracy of placement of medicaments without the need to remove the shoe. This reduces the workload for the farmer or veterinary professional and avoids unnecessary stress or discomfort to the animal.

Optionally, a fastener surrounds the shoe at the quarter portion.

By providing a suitable fastener, the shoe can be used on hooves of different girths. A fastener also allows the heel portion to be provided deliberately oversized and then appropriately tightened. This further ensures that unnecessary pressure in the sensitive hoof anatomy immediately beneath the dew claws.

Optionally, an integral or separable leg portion is connected to the quarter and heel portions for enveloping an animal's dew claws and at least part of its leg above said dew claws.

Optionally, two apertures are provided in a rear part of the leg portion corresponding with the positions of the dew claws.

In certain circumstances it may be desirable to increase the height of the shoe, e.g. to avoid ingress of liquid at its opening, or to cover a lesion above the dew claws. However, it may be desirable to allow the dew claws to extend outside of the shoe.

Further features and advantages of the present invention will become apparent from the claims and the following description.

### BRIEF DESCRIPTION OF THE DRAWINGS

Embodiments of the present invention will now be described by way of example only, with reference to the following diagrams, in which:—

FIG. 1 is side view of a shoe of the present invention encapsulating an animal hoof;

FIG. 2 is a rear view of the shoe of FIG. 1;

FIG. 3a is side view of an alternative shoe structure having separate medial and lateral sections for accommodating the medial and lateral claws;

FIG. 3b is an underside view of the shoe of FIG. 3a;

FIG. 4a is side view of an alternative shoe structure to that shown in FIGS. 3a and 3b; and

FIG. 4b is an underside view of the shoe of FIG. 4a.

### DETAILED DESCRIPTION

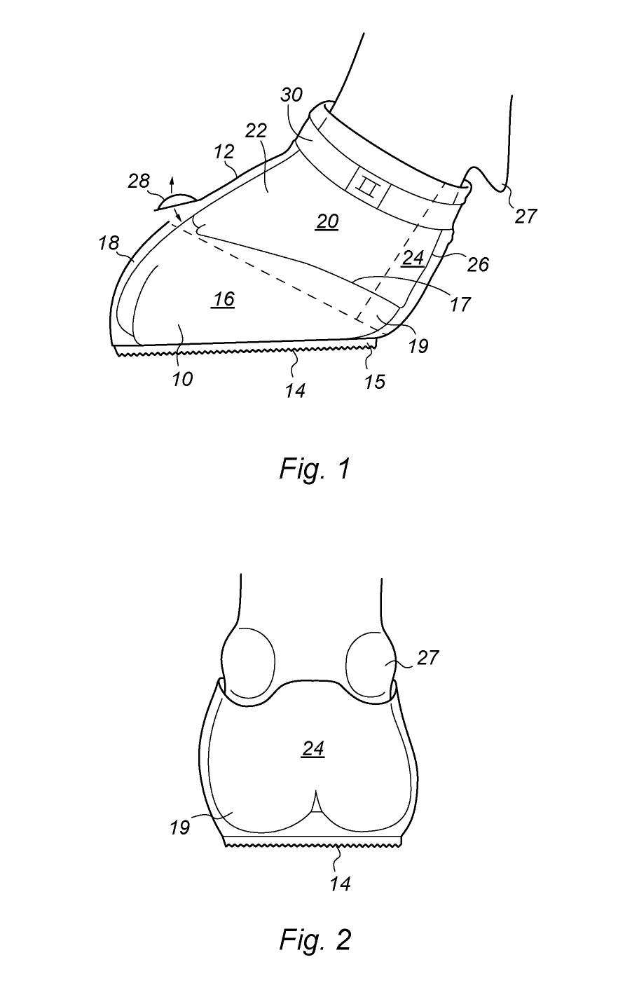

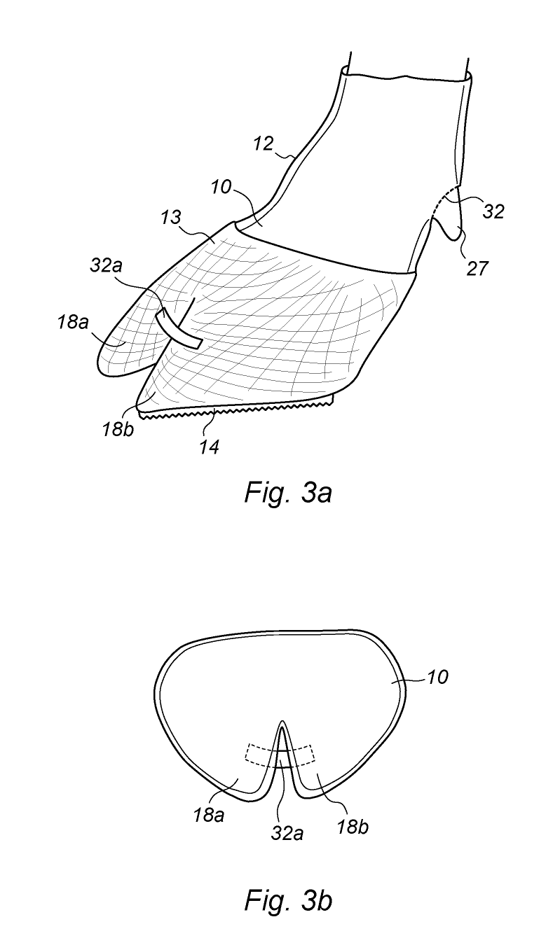

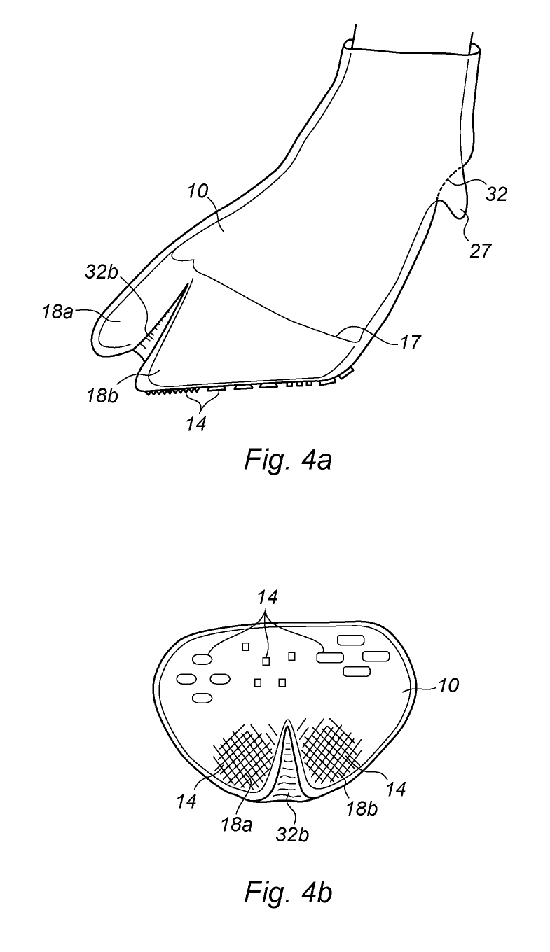

As shown in FIG. 1, an animal hoof 10 is encapsulated by a shoe 12 which may be notionally divided into at least four parts. The first notional part of the shoe is a treaded sole portion 14 formed from a relatively rigid elastomer or rubber material having a thickness which may, for example, fall within the range of 5 mm to 10 mm. The sole portion is shaped and dimensioned so as to correspond with the typical outline shape and size of a cloven-hooved animal's medial and lateral claws (e.g. see FIGS. 3b and 4b). It will be appreciated that shoes having differently sized and shaped sole portions may be provided to accommodate different animal types and sizes.

The second notional part of the shoe 12 is a vamp portion 16 extending upwardly from the periphery of the sole portion 14. The forward part 18 of the vamp portion 16 extends upwards over the toe of the hoof and terminates at a point which approximately overlies the animal's coronary band 17. The rear/lateral part of the vamp portion 16 extends proximate to the rear part 15 of the sole portion 14. Accordingly, the upper extent of the notional vamp portion 16 tapers downwardly from front to back, i.e. terminating at a position corresponding very approximately to the anatomical position of an animal's coronary band 17 and heel bulb 19.

The third notional part of the shoe 12 is a quarter portion 20 extending upwardly from the upper extent of the forward and lateral sides of the vamp portion 16 to overlie an animal's front and lateral pastern sections 22.

The fourth notional part of the shoe 12 is a heel portion 24 connected to both the vamp and quarter portions 16, 20 for at least partially enveloping the soft, sensitive area 26 above the heel bulb 19 and below the dew claws 27 (see FIG. 2). The elastomer or rubber material forming the heel portion 24 is relatively thinner than, and hence more flexible than, that employed at any other part of the shoe 12. The thickness of the material within the heel portion 24 may decrease in either a step-wise or progressive/gradual fashion along a notional line extending from its junction with the sole portion 14 to its edge proximate the dew claws 27.

More generally, the thickness of all of the vamp and/or quarter portions 16, 20 may decrease in either a step-wise or progressive/gradual fashion with increasing height above the sole portion 15; and/or with increasing distance along a substantially horizontal line from the coronary band 17 at the front of the hoof 10.

By providing targeted areas of reduced thickness and increased flexibility, pressure points within sensitive areas of the hoof 10, or areas prone to disease or injury, can be minimised or avoided. This in turn ensures that blood flow and ligament movement is not impeded which therefore promotes blood flow and healing.

As shown in FIG. 1, a sealable aperture or plug 28 is provided at the front of the shoe 12 proximate the meeting point of the vamp and quarter portions 16, 20. The plug 28 may be opened to permit ventilation of the enclosed hoof which, under certain circumstances, may promote healing of a surface lesion. Also, the plug 28 facilitates the introduction of a medicament onto the surface of the hoof, e.g. an ointment or cream applied via a syringe.

All notional parts of the shoe 12 may be integrally formed from a single piece of rubber or elastomeric material. It may alternatively be formed from a plurality of different pieces of rubber and/or elastomeric which have been, e.g. heat-welded together to form a unitary shoe 12. In either case, the absence of visible seams or joins ensures that the shoe 12 remains fully waterproof which is advantageous in terms of promoting the healing process for an encapsulated injured or diseased hoof. It is envisaged that the vamp, quarter and heel portions 16, 20, 24 may, for example, have thicknesses which are greater than 0.1 mm but less than 0.5 mm.

Silver particles and/or other ingredients having antimicrobial properties may be incorporated within the material of the shoe to assist healing of an enclosed hoof. The entire shoe 12, or one or more parts thereof, may be transparent to allow part(s) of the enclosed hoof to be viewed without the need to remove the shoe 12.

A fastener 30 extends circumferentially around the quarter portion 20 and heel portion 24 for retaining the shoe 12 on the hoof. The fastener 30 can be used to tighten the shoe 12 to an appropriate extent dependent on the type and size of the animal whilst avoiding placing excess pressure on the sensitive area 26 between the animal's heel bulb 19 and dew claws 27.

An alternative means of encapsulating an animal hoof 10 within a shoe 12 is shown in FIGS. 3a and 4a. The forward part 18 of the vamp portion 16 is divided—below the height of the animal's coronary band 17—into separate medial and lateral sections 18a, 18b for accommodating an animal's corresponding medial and lateral claws. This flexible structural arrangement affords natural movement of the medial and lateral claws as the animal walks. However, physically separating the medial and lateral claws may also be beneficial in some treatment scenarios.

In certain circumstances, it may be desirable to limit the degree to which the respective medial and lateral sections can be separated. As shown in FIGS. 3a and 3b, a relatively rigid bar or band 32a is orientated horizontally and connects the medial and lateral sections 18a, 18b together at a vertical height approximately midway between the sole 14 and the animal's coronary band 17.

An alternative arrangement is shown in FIGS. 4a and 4b, whereby the medial and lateral sections 18a, 18b are connected together by a relatively rigid (or elastic) interdigital web 32b. Advantageously, the web 32b may be formed integrally with the material of the shoe 12.

Although particular embodiments of the invention have been disclosed herein in detail, this has been done by way of example and for the purposes of illustration only. The aforementioned embodiments are not intended to be limiting with respect to the scope of the appended claims. It is contemplated by the inventor that various substitutions, alterations, and modifications may be made to the invention without departing from the scope of claims. Indeed, it is envisaged that individual features described above and illustrated in the drawings are, where the context allows, interchangeable with those of other embodiments. Furthermore, it is envisaged that different tread patterns may be provided on the sole 14 dependent upon factors such as animal type, the ground conditions and environment where an animal is located, and disease type. Multiple different tread patterns and/or heights may be provided on different regions of the sole 14 as illustrated schematically in FIG. 4b. Textured surfaces may also be provided on the inner surface of the sole of the shoe 12. As shown in FIG. 3a, a stiffening material may be applied over the external surface of the vamp, quarter and heel portions 16, 20, 24 to provide additional strength and durability. The stiffening material may be a bonded fabric or carbon fibre. Finally, in certain circumstances it may be desirable to increase the overall height of the shoe 12, e.g. to avoid ingress of liquid at its opening, or to cover a lesion situated above the dew claws. However, it may be desirable to allow the dew claws to extend outside of the shoe via a pair of apertures such as those illustrated in FIGS. 3a and 4a.

1. A therapeutic shoe for cloven-hooved lactating animals, said therapeutic shoe comprising:
a sole portion for supporting undersides of an animal's medial and lateral claws;
a vamp portion connected to the sole portion for at least partially enveloping an animal's hoof wall between its toe, heel and coronary band;
a quarter portion connected to the vamp portion for at least partially enveloping an animal's front and lateral pastern sections; and
a heel portion connected to both the vamp and quarter portions for at least partially enveloping an animal's heel and the area beneath the dew claws;
wherein the material of the shoe at said heel portion is relatively more deformable than the material of the shoe at any of said sole, vamp or quarter portions.

2. A therapeutic shoe according to claim 1, wherein the increase in relative deformability of the heel portion is achieved by reducing the thickness and/or increasing the elasticity of the material of the shoe at said heel portion relative to that of the shoe at any of said sole, vamp or quarter portions.

3. A therapeutic shoe according to claim 2, wherein the relatively thinner material of the shoe at said heel portion has a variable thickness; and wherein a portion thereof most proximate the dew claws is relatively thinner and more flexible than the material of the remainder of the heel portion.

4. A therapeutic shoe according to claim 1, wherein the increase in relative deformability of the heel portion is achieved by oversizing the heel portion.

5. A therapeutic shoe according to claim 1, wherein the material of the shoe at said sole portion is relatively thicker and/or more rigid than the material of any other part of the shoe.

6. A therapeutic shoe according to claim 1, wherein the foremost part of the vamp portion is divided into separate medial and lateral sections for accommodating an animal's medial and lateral claws.

7. A therapeutic shoe according to claim 6, wherein an auxiliary connection is provided between the medial and lateral sections to resist and/or limit their physical separation.

8. A therapeutic shoe according to claim 7, wherein the auxiliary connection is in the form of a web connected between opposite inner surfaces of the medial and lateral sections.

9. A therapeutic shoe according to claim 7, wherein the auxiliary connection is in the form of band connected between the medial and lateral sections.

10. A therapeutic shoe according to claim 1, wherein the outer surface of the sole is provided with a textured or patterned tread.

11. A therapeutic shoe according to claim 1, wherein the inner hoof-facing surface of the sole is provided with a textured or patterned tread.

12. A therapeutic shoe according to claim 1, wherein a sealable aperture is provided on the front of the shoe.

13. A therapeutic shoe according to claim 12, wherein the sealable aperture overlies the front of the vamp and/or quarter portion(s).

14. A therapeutic shoe according to claim 1, wherein the entire shoe is integrally formed from a single piece of rubber or elastomeric material.

15. A therapeutic shoe according to claim 14, wherein the rubber or elastomeric material is breathable.

16. A therapeutic shoe according to claim 1, wherein at least part of the material of the shoe is transparent.

17. A therapeutic shoe according to claim 1, wherein a fastener surrounds the shoe at the quarter portion.

18. A therapeutic shoe according to claim 1, wherein an integral or separable leg portion is connected to the quarter and heel portions for enveloping an animal's dew claws and at least part of its leg above said dew claws.

19. A therapeutic shoe according to claim 18, wherein two apertures are provided in a rear part of the leg portion corresponding with the positions of the dew claws.
